(19) United States
(12) Patent Application Publication
(10) Pub. No.: US 2009/0066186 A1
(43) Pub. Date: Mar. 12, 2009

(54) Non-contact actuator

(75) Inventors: Alex Horng, Kaohsiung City (TW); I-Yu Huang, Kaohsiung City (TW)

Correspondence Address: BACON & THOMAS, PLLC, 625 SLATERS LANE, FOURTH FLOOR, ALEXANDRIA, VA, 22314-1176, US

(73) Assignee: Sunonwealth Electric Machine Industry Co., Ltd., Kaohsiung City (TW)

(21) Appl. No.: 11/902,226

(22) Filed: Sep. 20, 2007

(30) Foreign Application Priority Data
Sep. 6, 2007 (TW) 096133198

(51) Int. Cl. H02N 1/00

(52) U.S. Cl. 310/309

(57) ABSTRACT

The present invention relates to a non-contact actuator located on a substrate and at least including a plate and a bushing. When a voltage is applied externally, the plate is bent by the attraction of the substrate and won't be contacted with the substrate. A counteraction force is generated when the plate withstands the electrostatic force of the substrate. After the voltage is removed, the counteraction force and an elastic tension generated by recovering from a curved state of the plate to an original state are employed to generate bouncing motion of the plate and the bushing and further proceed step movement of the actuator. Because of no friction between the plate and the substrate, the present invention only requires a rather small voltage and consumes the minimum current so as to lower the driving voltage and reduce the current consumption and defacement of device for longer lifespan.

### FIELD OF THE INVENTION

The present invention relates to a non-contact actuator, which prevents a plate from being contacted with a substrate, while the plate is attracted by the substrate, by adding the flexural rigidity of the plate so as to lower the friction drag, reduce the driving voltage and defacement of device, and prolong the lifespan thereof.

### BACKGROUND OF THE INVENTION

A micro fan structure includes micro fan blades produced by a self-assembly technique, and a micro motor constituted by using a micro-actuator as a rotor, in which the actuation concept of the micro-actuator is illustrated by FIG. 1:

The micro-actuator structure includes a substrate 10, which is usually a silicon substrate and has a silicon-nitride insulation film with a coating thickness around 0.6 μm thereon; an actuator located on the substrate 10 and having a plate 20 and a bushing 21, in which the plate 20 is parallel to the substrate 10, and the bushing 21 is connected to a front end of the plate 20 so as to be perpendicular to the substrate 10 as shown in FIG. 1(a).

When a capacitive structure is formed by the plate 20 and the bushing 21, electrostatic force is available on the plate 10. Therefore, when a positive bias voltage is applied externally, the plate 20 is attracted by the substrate 10 due to the electrostatic force, such that a rear end of the plate 20 is in contact with the substrate 10 as shown in FIG. 1(b).

When the positive bias voltage is increased up to a priming voltage, as the friction between the rear end of the plate 20 and the substrate 10 is smaller than that between the bushing 21 and the substrate 10, the plate 20 is bent to cause a large-area contact between its rear end and the substrate 10 and is stored with an elastic tension as shown in FIG. 1(c).

After the applied voltage is removed, the friction between the rear end of the plate 20 and the substrate 10 is larger than that between the bushing 21 and the substrate 10. As a result, the stored elastic tension is immediately released to drive the actuator to actuate and displace as shown in FIG. 1(d).

When a negative bias voltage is further applied, the plate 20 will also be attracted by the substrate 10 to result in repeated movement, so that the plate 20 is continuously actuated on the substrate 10.

During the actuation course of the actuator, there are two contact surfaces between the actuator and the substrate 10, namely, a contact surface between the rear end of the plate 20 and the substrate 10 and a contact surface between the bushing 21 and the substrate 10. The condition for a actuator to have elastic tension lies in that the positive (negative) voltage applied between the actuator and the substrate 10 shall be large enough to make the friction between the bushing 21 and the substrate 10 greater than that between the rear end of the plate 20 and the substrate 10. However, such condition inevitably introduces the shortcomings of high driving voltage, high current consumption and defacement of device.

### SUMMARY OF THE INVENTION

In view of the foregoing concern, the present invention thus provides a non-contact actuator that lowers driving voltage, and reduces current consumption and defacement of device to prolong lifespan.

The non-contact actuator is located on a substrate and at least includes a plate and a bushing.

When a positive (negative) bias voltage is externally applied between the actuator and the substrate, the plate is bent by the attraction of the substrate due to an electrostatic force while it won't be contacted with the substrate. Hence, the actuator only has one contact surface between the bushing and the substrate but is free of the friction resulting from the contact between the plate and the substrate. The present invention only requires a rather low voltage and consumes a minimum current to proceed a bouncing movement arising from the counteraction force generated by the plate itself to withstand the electrostatic force and the elastic tension while the plate recovers from a curved state to its original state.

### BRIEF DESCRIPTION OF THE DRAWINGS

FIG. 1 is a schematic view showing the movement of conventional structure;

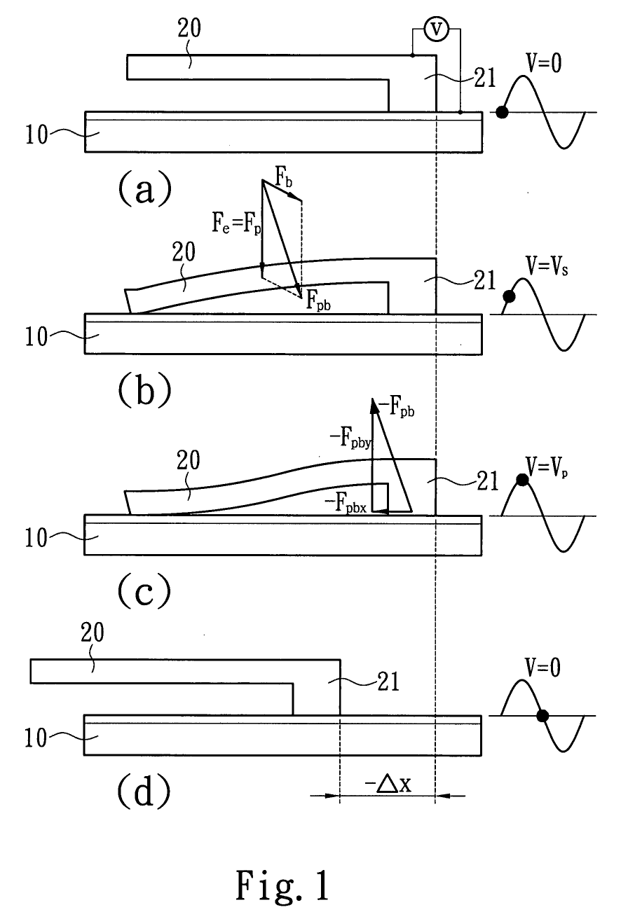

FIG. 2 is an external schematic view of the present invention; and

FIG. 3 is a schematic view showing the movement of the present invention.

### DETAILED DESCRIPTION OF THE PREFERRED EMBODIMENT

To make the object, features and efficacy of the present invention more comprehensive, preferred embodiments of the present invention are enumerated along with the detailed illustrative description.

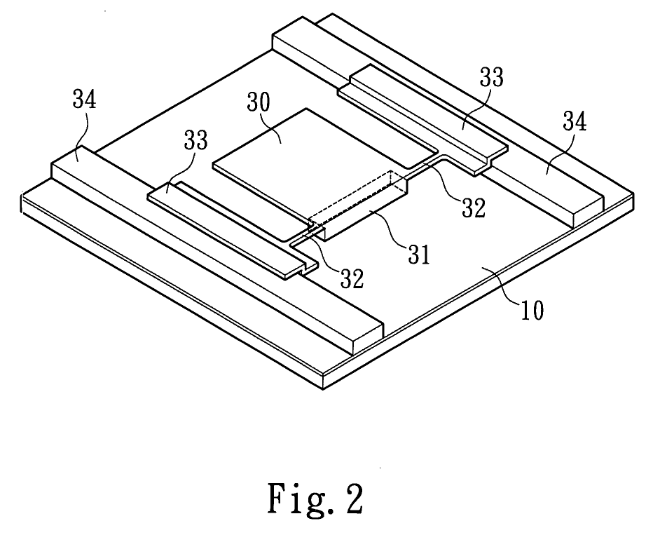

Please refer to FIG. 2. The actuator is located on a substrate 10 and includes a plate 30, a bushing 31, at least two support beams 32, at least two sliding seats 33, and at least two rails 34.

The at least two rails 34 are located on the substrate 10 and are in form of straight line pattern or curved pattern with an equal distance therebetween, such as a pattern of two parallel straight lines or a pattern of two concentric circles.

The at least two sliding seats 33 are mounted across the aforementioned two rails 34 and have a support beam 32 extended from the respective sliding seat. The at least two support beams are connected with the plate 30 and have chamfers formed at corners intersected by the support beam and each of the sliding seats 33 and the plate 30.

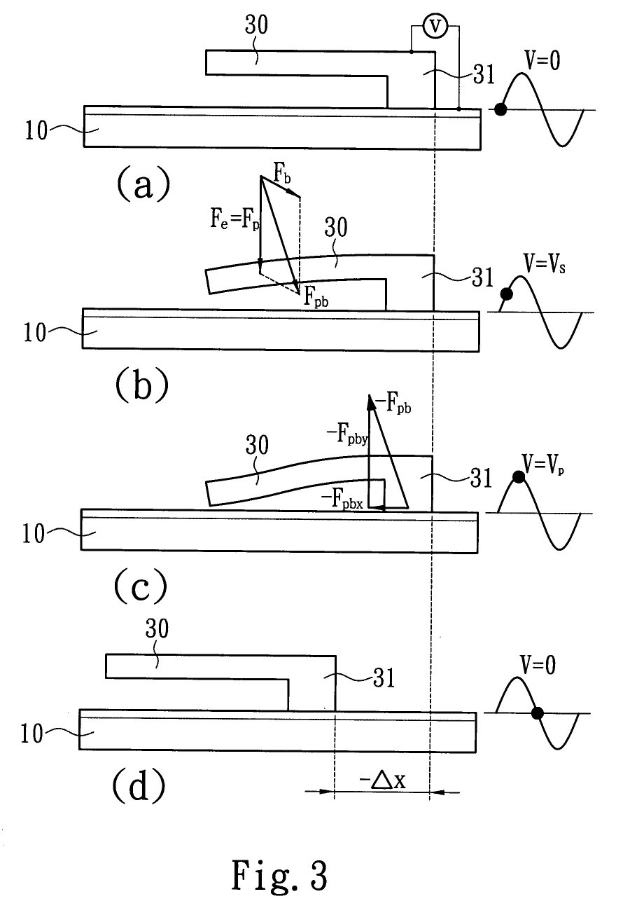

Please further refer to FIG. 3. The plate 30 is parallel to the substrate 10, and the bushing 31 is connected to a front end of the plate 30 and is perpendicular to the substrate 10 as shown in FIG. 3(a).

When a positive bias voltage is applied externally, a rear end of the plate 30 is bent by the attraction of the substrate due to electrostatic force but won't be contacted with the substrate 10 as shown in FIG. 3(b).

When a positive bias voltage is increased up to a priming voltage, as there is only one contact surface between the bushing 31 and the substrate 10, a rather small voltage is required and a minimum current is consumed to generate a counteraction elastic tension for the plate to withstand the electrostatic force as shown in FIG. 3(c).

After the applied voltage is removed, the counteraction force stored in the plate 30 and the elastic tension resulted from recovering from a curved state of the plate 30 to its original state are immediately released. The rebounding force drives the plate 30 and the bushing 31 to bounce and jump, so as to deliver a step motion of the actuator as shown in FIG. 3(d).

When a negative bias voltage is applied additionally, likewise, the plate 30 will be attracted by the substrate 10 to generate repeated motion. As the plate 30 won't be contacted with the substrate 10, it can proceed (continuous motion on the substrate 10.

When a positive (negative) bias voltage is applied, the plate is attracted by the substrate 10 due to the effect of an electrostatic force but won't be contacted by the substrate 10. Therefore, a rather small voltage is required and a minimum current is consumed to generate a counteraction elastic tension by using the plate 30 to withstand the electrostatic force. After the applied voltage is removed, the plate 30 still proceeds the bouncing motion by the rebounding force of the elastic tension stored therein to perform a step movement of the actuator.

In sum, the present invention possesses the aforementioned advantages indeed. From the above-mentioned characteristics those features not only have a novelty among similar products and a progressiveness but also have an industry utility.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A non-contact actuator, locate on a substrate and comprising a plate and a bushing, wherein a rear end of said plate is bent by an attraction of said substrate while externally applying a positive (negative) power between said actuator and said substrate but won't be contacted with said substrate, and said actuator proceeds a step movement by a rebounding force generated by recovering from a curved state of said plate to an original state after removing said power.

2. The non-contact actuator as set forth in claim 1, wherein there are at least two rails disposed on said substrate, a sliding seats disposed across each respective rail, and a support beam extended from each respective sliding seat and connected with said plate.

3. The non-contact actuator as set forth in claim 2, wherein said at least two rails are selected from one pattern of a straight line and a curve and are disposed with an equal distance therebetween.

4. The non-contact actuator as set forth in claim 2, wherein a chamfer is formed at a corner intersected by said support beam and each of said sliding seat and said plate.
